(19) United States
(12) Patent Application Publication
(10) Pub. No.: US 2025/0126312 A1
(43) Pub. Date: Apr. 17, 2025

(54) SYSTEMS AND METHODS FOR CONTENT OUTPUT

(71) Applicant: Comcast Cable Communications, LLC, Philadelphia, PA (US)

(72) Inventor: Alexander GILADI, Denver, CO (US)

(21) Appl. No.: 18/913,446

(22) Filed: Oct. 11, 2024

Related U.S. Application Data
(60) Provisional application No. 63/589,865, filed on Oct. 12, 2023.

(51) Int. Cl. H04N 21/262

(52) U.S. Cl. CPC H04N 21/26241

(57) ABSTRACT

Methods and systems for content output are disclosed. A client device may receive a media presentation description (MPD). The MPD may comprise a first element associated with a portion of a content item. The first element may comprise a uniform resource identifier (URI). The URI may comprise data associated with responding to a request for a second element associated with a supplemental content item. The request for the second element may be sent to at least one processing device. The request may comprise the URI. The second element may be received from the at least one processing device based on the data associated with responding to the request for the second element. Output of the supplemental content item may be caused during output of the portion of the content item based on replacing the first element with the second element.

### CROSS-REFERENCE TO RELATED APPLICATIONS

This application claims the benefit of U.S. provisional Application No. 63/589,865, filed Oct. 12, 2023, which is incorporated by reference in its entirety.

### BACKGROUND

A media presentation description (MPD) may be used, such as by a client device, to cause output of a content item and/or one or more supplemental content items (e.g., during advertisement breaks in the content item). The MPD may comprise various elements that each describe a period (e.g., portion) of the content item. Some of the elements may cause the client device to request a remote element for output during the corresponding period. It may be desirable for the client device to request the remote element at a time that is proximate to output of the corresponding period. However, the client device often requests the remote element far in advance of the output of the corresponding period. As such, improved techniques for content output are needed.

### SUMMARY

Methods and systems for content output are disclosed. A universal resource identifier (URI) may be inserted into a media presentation description (MPD). The URI may contain various parameters. The parameters may be used to ensure that a response to a request for a remote element is fulfilled just-in-time (e.g., thirty seconds, one minute, etc. before output of the corresponding period), instead of far (e.g., thirty minutes, one hours, etc.) in advance of the output of the corresponding period. A client device may request the remote element, such as from a processing device, by sending the URI to a processing device. The processing device may retrieve the remote element. If the processing device determines, based on the parameters, that it is too early to send the response to the request, the processing device may cache the response. If the processing device determines, based on the parameters, that it is time to send the response to the request, the processing device may send the second element to the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example method.

FIG. 3 is an example method.

FIG. 4 is an example method.

FIG. 5 is an example computing device.

### DETAILED DESCRIPTION OF ILLUSTRATIVE EMBODIMENTS

Methods and systems for content output are disclosed. A client device (e.g., playback device, output device, etc.) may utilize a media presentation description (MPD) (e.g., a MPEG-DASH manifest file) to cause output of a content item. The MPD may comprise various elements (e.g., period elements XML elements), each of which may correspond to a particular portion (e.g., period) of the content item. The client device may utilize the information contained in a particular element to cause output of the corresponding portion of the content item.

One or more of the elements may be a remote element. A remote element is an element that is not fully contained in the MPD but is instead referenced in the MPD with a network location. For example, a remote element may be associated with a first attribute (e.g., @xlink: href) and a second attribute (e.g., @xlink: actuate). The first attribute may contain the network location for the remote element. The network location may comprise, for example, a hyper-text transfer protocol (HTTP) uniform resource locator (URL) link (e.g., using a simplified profile of XLink), or other universal resource identifier (URI) from which the corresponding portion may be downloaded, accessed, or retrieved. The network locations included within the MPD may point to more than one different location or source.

A remote element may be associated with first attribute (e.g., @xlink: href, ImportedMPD@uri, AlternativeMPD@uri) and a plurality of optional attributes (e.g., @xlink: actuate, ImportedMPD@earliestResolutionTimeOffset). The first attribute may contain the network location for the remote element. The network location may comprise, for example, a hyper-text transfer protocol (HTTP) uniform resource locator (URL) link (e.g., using a simplified profile of XLink), or other universal resource identifier (URI) from which the corresponding portion may be downloaded, accessed, or retrieved. The network locations included within the MPD may point to more than one different location or source. The optional attributes may govern aspects such as timing of requests to the network location, timing constraints on playback and its termination, etc. The remote element may need to go through stages of preprocessing after its retrieval from the network location.

A remote element may comprise an MPD. For example, a remote element may comprise a single XML element of type MPDType. If a remote element comprises a single XML element of type MPDType, everything contained in the MPD may be a descendent element (e.g., a child element, a grandchild element, etc.) of the single XML element.

The second attribute of a remote element may specify a value of the resolution model associated with the remote element. If the value of the resolution model is a first value (e.g., “onLoad”), the client device may be required to immediately issue a request (e.g., an HTTP GET request) to one or more server devices for the remote element based on initiation of output of the content item (e.g., at MPD parse time). If the value of the resolution model is a second value (e.g., “onRequest”), the client device may instead issue the request for the remote element at a time when an XML parser accesses the remote element. The element received in the response to the request may then be inserted into the MPD in place of the original remote element in the MPD.

A remote element may be associated with a supplemental content item. The client device may request a remote element associated with a supplemental content item and may cause output of the supplemental content item during one or more advertisement breaks (e.g., avails, supplemental content insertion opportunities) in the content item. For example, the client device may request a remote element associated with a supplemental content item to perform dynamic (e.g., just-in-time) ad insertion during output of the content item.

However, the above-described technique for requesting remote elements is associated with various inefficiencies. First, if the client device issues the request for the remote element based on initiation of output of the content item (e.g., at MPD parse time) or a time when an XML parser accesses the remote element, the client device may receive the supplemental content element far in advance of the advertisement break. As such, the client device may need to store the supplemental content element for a long period of time before eventually causing output of the supplemental content item. Second, the MPD may be refreshed (e.g., updated) frequently (e.g., every two seconds). As such, the elements in the MPD may be frequently refreshed (e.g., updated). This may cause the client device to repeatedly issue requests for the remote element each time the MPD is updated. Described here are techniques for content output that address these inefficiencies.

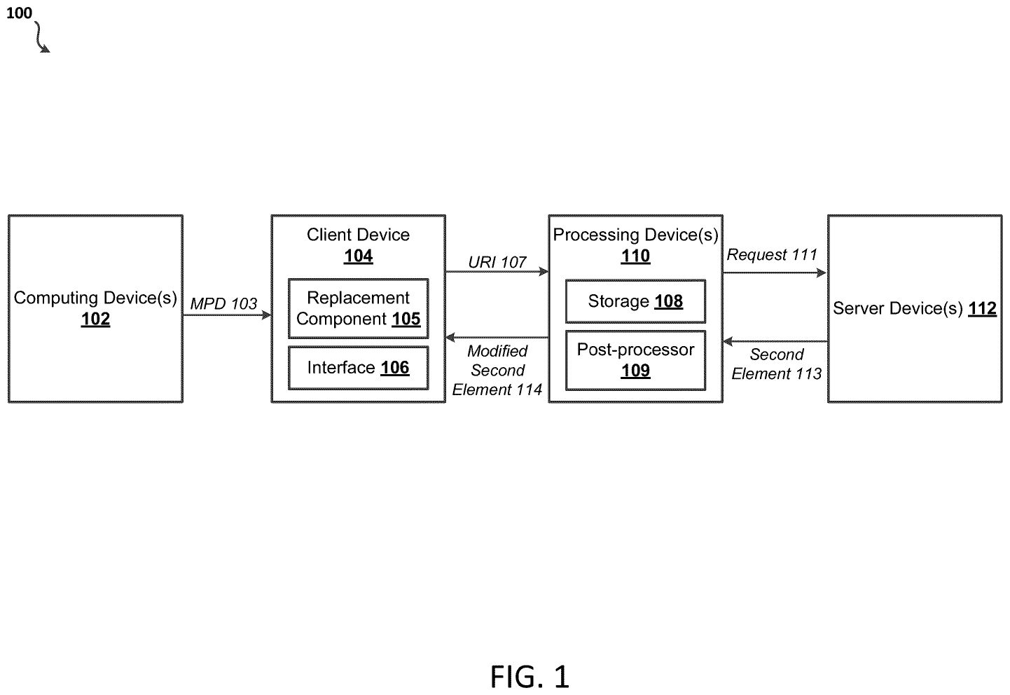

FIG. 1 is an example system 100 for content output. The system 100 may comprise one or more computing devices 102, a client device 104, one or more processing device(s) 110, and one or more server device(s) 112. The system 100 may be used to facilitate content output using Dynamic Adaptive Streaming over HTTP (DASH) or MPEG-DASH.

The computing device(s) 102 may comprise a MPD manipulator device. The computing device(s) 102 may comprise one or more devices configured to write and/or re-write MPDs. The computing device(s) 102 may be located at an origin server associated with a content delivery network, a packager associated with the content delivery network, a node associated with the content delivery network, or co-located, such as with a virtualized cable modem termination system (CMTS) location.

The computing device(s) 102 may be configured to receive a media presentation description (MPD). The computing device(s) 102 may receive the MPD from a MPD generator and/or DASH packager. The MPD may be associated with a content item. The MPD may comprise one or more elements (e.g., period elements, XML elements, etc.). Each of the one or more elements may correspond to a particular portion of the content item. For example, the element corresponding to a particular portion of the content item may contain information describing various aspects of the corresponding portion that may be useful for the client device 104 to cause output (e.g., playback) of the corresponding portion.

The MPD may comprise at least one first element. The at least one first element may correspond to or be associated with at least one portion of the content item. For example, the at least one first element may correspond to or be associated with at least one supplemental content insertion opportunity in the content item.

The at least one first element may be a remote element. For example, the at least one first element may not contain all of the information needed by a client device to cause output of the supplemental content item. Instead, the at least one first element may be associated with a first attribute (e.g., @xlink: href) and a second attribute (e.g., @xlink: actuate). The first attribute may contain the network location associated with the at least one first element. The network location may comprise, for example, a HTTP URL link (e.g., using a simplified profile of XLink) associated with the at least one first element. The second attribute of the at least one first element may specify a value of the resolution model associated with the at least one first element.

The computing device(s) 102 may determine a URI (e.g., a tag URI) associated with the at least one first element. The URI may comprise the network location and additional information about the at least one first element. For example, the URI may be associated with a new schema that contains parameters (e.g., data) beyond the network location. The URI may comprise data defining the new schema. The URI may comprise data associated with responding to a request (e.g., from a client device) for a second element associated with a supplemental content item to be inserted in the least one supplemental content insertion opportunity in the content item. The data associated with responding to the request for the second element may comprise one or more of an identification (ID) associated with the second element, a time window during which to send the second element, a time window during which to store the second element, an instruction to use replacement content contained in the at least one first element if a failure to respond the request for the second element occurs, and a current time. The URI may further comprise additional data. The additional data may comprise one or more of an identification ID associated with the at least one portion of the content item, a start time associated with the at least one portion of the content item, and a duration associated with the at least one portion of the content item. The data associated with responding to a request and/or the additional data may be percent-encoded in order to maintain compatibility with the definition of the URI in IETF RFC 3896.

The computing device(s) 102 may insert the URI into the at least one first element. For example, the computing device(s) 102 may insert the URI into the first attribute (e.g., @xlink: href) of the at least one first element. The computing device(s) 102 may insert the URI based on (e.g., in response to) detection of an SCTE 35 cue message in the incoming content stream and/or based on an out of band application programming interface (API) mechanism such as SCTE 224 or SCTE 250. The computing device(s) 102 may send the MPD with the inserted URI (e.g., MPD 103) to the client device 104. As an alternative to determining the URI and inserting the URI into the MPD, a new URI schema with the same functionality may be registered.

The client device 104 may receive the MPD 103. The client device 104 may determine the URI based on the MPD 103. The client device 104 may extract the URI from the MPD 103. The client device 104 may send the URI to the processing device(s) 110. The client device 104 may send the URI to the processing device(s) 110 based on the second attribute (e.g., @xlink: actuate) associated with the at least one first element. For example, the client device 104 may send the URI to the processing device(s) 110 based on initiation of output of the content item (e.g., at MPD parse time) or at a time when an XML parser accesses the at least one first element. The sending of the URI to the processing device(s) 110 may comprise a request from the client device 104 for the second element associated with the supplemental content item.

The processing device(s) 110 may comprise one or more computing devices. The processing device(s) 110 may comprise software with storage capability. The processing device(s) 110 may be a part (e.g., component) of the client device 104 (e.g., a software library on the client device 104). The processing device(s) 110 may be separate from the client device 104.

The processing device(s) 110 may receive the URI. The processing device(s) 110 may determine if the URI and/or the request for the second element is received before the earliest resolution time as indicated in the URI. If the processing device(s) 110 determines that the URI and/or the request for the second element is received before the earliest resolution time as indicated in the URI, the processing device(s) 110 may return an error, or a “canned” response instructing the client device 104 not to try resolving the requested link, or a “canned” Period element containing “slate” content.

The processing device(s) 110 may determine one or more second elements 113. The processing device(s) 110 may determine the second element(s) 113 based on (e.g., in response to) determining that the URI and/or the request for the second element is not received before the earliest resolution time as indicated in the URI. The processing device(s) 110 may determine the second element(s) 113 based on the data associated with responding to the request for the second element. Determining the second element(s) 113 may comprise sending a request 111 to the server device(s) 112 for the second element(s) 113 and/or receiving the second element(s) 113 from the server device(s) 112. Determining the second element(s) 113 may comprise retrieving the second element from a storage 108 associated with the processing device(s) 110.

The processing device(s) 110 may determine whether the second element(s) 113 are in the storage 108 associated with the processing device(s) 110. The processing device(s) 110 may determine whether the second element is in the storage 108 associated with the processing device(s) 110 based on the ID associated with the second element(s) 113. If the processing device(s) 110 determine that the second element(s) 113 are in the storage 108 associated with the processing device(s) 110, determining the second element(s) 113 may comprise retrieving the second element from a storage 108 associated with the processing device(s) 110. Conversely, if the processing device(s) 110 determine that the second element(s) 113 are not in the storage 108 associated with the processing device(s) 110, determining the second element may comprise sending the request 111 for the second element(s) 113 to the server device(s) 112, and receiving the second element(s) 113 from the server device(s) 112.

The processing device(s) 110 may determine whether the current time is within the time window during which to send the second element(s) 113. The processing device(s) 110 may determine whether the current time is within the time window during which to send the second element based on comparing the current time to the time window during which to send the second element. If the processing device(s) 110 determines that the current time is within the time window during which to send the second element, the processing device(s) 110 may send the second element(s) 113 to the client device 104. Alternatively, if the processing device(s) 110 determines that the current time is not within the time window during which to send the second element, the processing device(s) 110 may store (e.g., cache) the second element(s) 113 in the storage 108. For example, the processing device(s) 110 may store (e.g., cache) the second element(s) 113 in the storage 108 based on determining that the current time is within the time window during which to store the second element.

If the second element(s) 113 are in the storage 108 and the current time is within the time window during which to send the second element, the processing device(s) 110 may determine if there is a parameter (e.g., data) in the URI allowing re-resolution. If the processing device(s) 110 determine that there is a parameter (e.g., data) in the URI allowing re-resolution, the processing device(s) 110 may request a new period. The processing device(s) 110 may request the new period using an XLink HTTP URL to request the period element(s) from an external URL resolver in the network. Requesting the period element(s) from an external URL resolver in the network may comprise requesting the period element(s) from an external URL resolver in the network using regular or conditional GET requests. If the period element(s) are requested from an external URL resolver in the network using conditional GET requests, an clectronic tag (e.g., a hash of the canonicalized response) may be used to avoid unnecessary traffic. Alternatively, the processing device(s) 110 may request the new period from one or more server devices (e.g., ad servers) and/or an ad decisioning system. The processing device(s) 110 may request the new period from the server device(s) and/or ad decisioning system using protocols such as IAB VAST or SCTE 130. The result of the request may be an MPD URL. If the result of the request is an MPD URL, the processing device(s) 110 may further request the MPD and remove period elements from it.

The processing device(s) 110 may comprise a post-processor device 109. The post-processor device 109 may be configured to modify (e.g., perform post-processing on) the second element(s) 113. The post-processor device 109 may modify (e.g., perform post-processing on) the second element(s) 113 before the processing device(s) 110 sends the second element to the client device 104. The post-processor device 109 may modify the second element(s) 113 based on the additional data contained in the URI. The processing device(s) 110 may send the modified second element(s) 114 to the client device 104.

The post-processor device 109 may modify the second element(s) 113 based on inserting, into the second element(s) 113, the ID associated with the at least one portion of the content item. If there is a need for repeatable generation, a “seed” string may be included as a part of the URI and its cryptographic hash (e.g., SHA-1) may be the ID of the first portion of the at least one portion of the content item. For each subsequent portion ID, a cryptographic hash of the previous portion ID may be used. Alternatively, if the second element(s) 113 already contain the ID, the unique ID may be a cryptographic hash and/or concatenation of the IDs and some content identifier (e.g., an AdID or Entertainment Identifier Registry (EIDR) identifier, or MPD@id attribute if the input is an MPD).

The post-processor device 109 may modify the second element(s) 113 based on inserting, into the second element(s) 113, the start time associated with the at least one portion of the content item and/or the duration associated with the at least one portion of the content item. The post-processor device 109 may modify the second element(s) 113 based on inserting, into the second element(s) 113, an advertisement beacon. For example, the post-processor device 109 may include the beacon URLs in an XML element (e.g., as part of the VAST response or a DFASH event such as the DASH Callback event). The post-processor device 109 may further modify the existing beacon URLs by inserting unique viewer and/or session identifier(s) into the beacon URL. The response may then be both returned to the client device 104 and cached for use with further client resolution requests.

The client device 104 may be configured to receive the second element(s) 113 or the modified second element 114 from the processing device(s) 110. The client device 104 may cause output of the supplemental content item. The client device 104 may cause output of the supplemental content item during output of the at least one portion (e.g., supplemental content insertion opportunity) of the content item. The client device 104 may comprise a replacement component 105. The client device 104 may cause output of the supplemental content item based on replacing the at least one first element in the MPD with the second element(s) 113 (or the modified second element 114). The replacement component 105 may replace the at least one first element in the MPD with the second element(s) 113 (or the modified second element 114). The client device 104 may use the MPD including the second element(s) 113 (or the modified second element 114) to cause output, via an interface 106, of the supplemental content item during output of the at least one portion (e.g., supplemental content insertion opportunity) of the content item.

The client device 104 may be at least one of a set-top box, a streaming video player, a laptop, a television, a smartphone, a tablet, a desktop computer, or any other device capable of presenting content to a user. The client device 104 may comprise any combination of a hardware element, such as a set-top cable box, or a software element, such as a web browser or other software adapted to playback video. The client device 104 may comprise an interface (e.g., display) 106 for displaying content to a user of the client device 104. It is understood that the interface 106 may be part of the client device 104, such as in the example that the client device 104 is a tablet, or may be located externally to the client device 104, such as in the example that the client device 104 is a set-top box and the interface 106 is a television set connected to the set-top box.

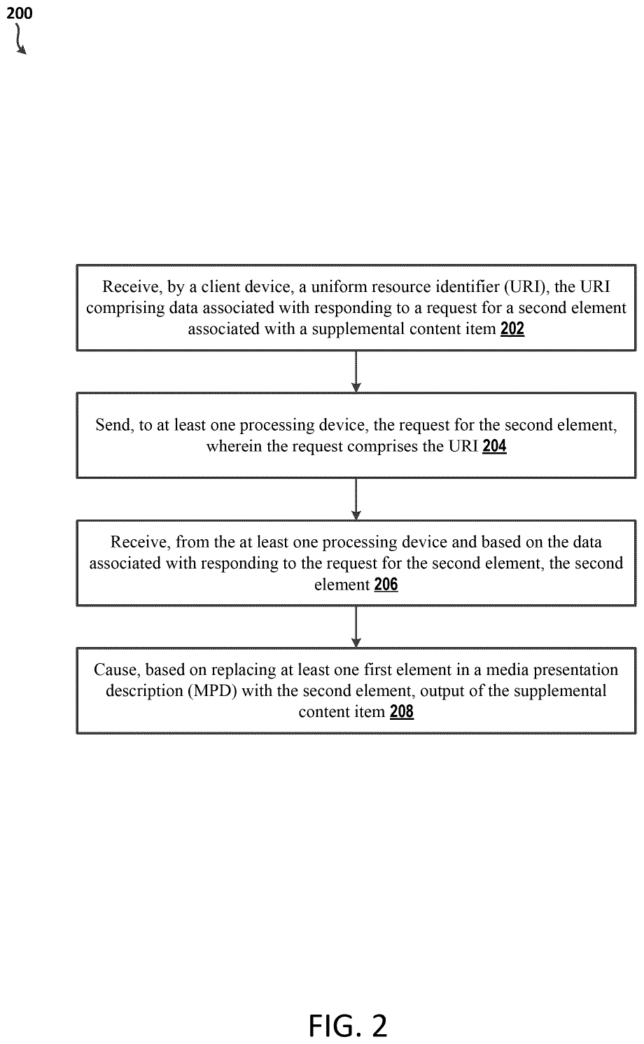

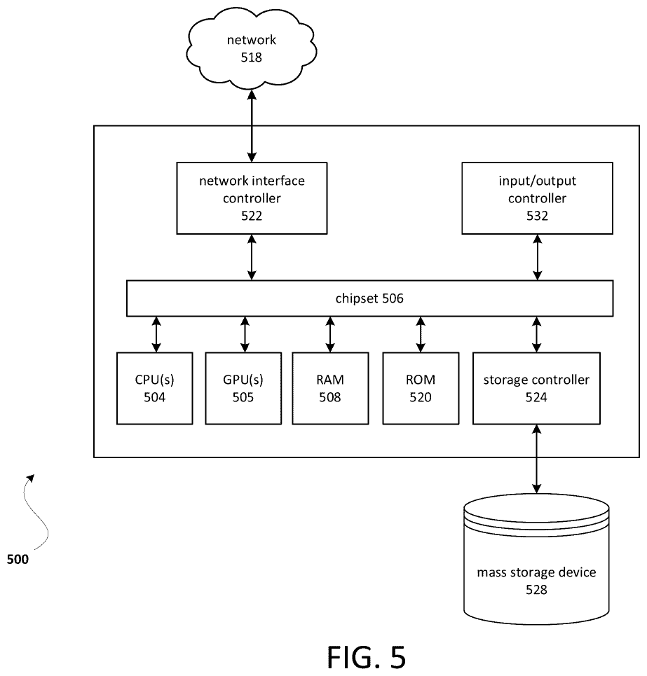

FIG. 2 is a flow diagram illustrating an example method 200. The method 200 may comprise a computer implemented method for content output. A system and/or computing environment, such as the system 100 of FIG. 1 and/or the computing environment of FIG. 5, may be configured to perform the method 200. For example, the client device 104 of FIG. 1 may be configured to perform the method 200.

At 202, a MPD may be received. The MPD may be received by a client device. The MPD may comprise at least one first element associated with at least one portion of a content item. The at least one portion of the content item may comprise at least one supplemental content insertion opportunity in the content item. The at least one first element may comprise a URI. For example, the at least one first element may be associated with a first attribute (e.g., @xlink: href). The first attribute may comprise the URI.

The URI may comprise data associated with responding to a request for a second element. The second element may be associated with a supplemental content item. The data associated with responding to the request for the second element may comprise one or more of an ID associated with the second element, a time window during which to send the second element (e.g., to the client device), a time window during which to store the second element, an instruction to use replacement content contained in the at least one first element if a failure to respond the request for the second element occurs, or a current time. The URI may further comprise additional data. The additional data may comprise one or more of an ID associated with the at least one portion of the content item, a start time associated with the at least one portion of the content item, or a duration associated with the at least one portion of the content item.

The client device may determine the URI based on the MPD and/or extract the URI from the MPD. At 204, the request for the second element may be sent. The request for the second element may be sent to at least one processing device. The request may comprise the URI. The request may be sent based on a second attribute (e.g., @xlink: actuate) associated with the at least one first element. For example, the request may be sent based on initiation of output of the content item (e.g., at MPD parse time) or at a time when an XML parser accesses the at least one first element.

The second element may be contained in a second MPD (e.g., a single XML element of type MPDType). If the second element is contained in a second MPD, sending the request for the second element may comprise sending a request for the second MPD.

At 206, the second element may be received. The second element may be received from the at least one processing device. The second element may be received based on the data associated with responding to the request for the second element. For example, the at least one processing device may be configured to send the second element to the client device based on the data associated with responding to the request for the second element.

The at least one processing device may determine the second element based on the data associated with responding to the request for the second element. Determining the second element may comprise sending a request to at least one server device (e.g., ad server) for the second element and/or receiving the second element from the at least one server device. Determining the second element may comprise retrieving the second element from a storage 108 associated with the at least one processing device.

The at least one processing device may determine whether the second element is in the storage associated with the at least one processing device. The at least one processing device may determine whether the second element is in the storage associated with the at least one processing device based on the ID associated with the second element. If the at least one processing device determine that the second element is in the storage associated with the at least one processing device, determining the second element may comprise retrieving the second element from the storage associated with the at least one processing device. Conversely, if the at least one processing device determines that the second element is not in the storage associated with the at least one processing device, determining the second element may comprise sending the request for the second element to the at least one server device and receiving the second element from the at least one server device.

The at least one processing device may determine whether the current time is within the time window during which to send the second element. The at least one processing device may determine whether the current time is within the time window during which to send the second element based on comparing the current time to the time window during which to send the second element. If the at least one processing device determines that the current time is within the time window during which to send the second element, the at least one processing device may send the second element to the client device. Alternatively, if the at least one processing device determines that the current time is not within the time window during which to send the second element, the at least one processing device may store (e.g., cache) the second element in the storage. For example, the at least one processing device may store (e.g., cache) the second element in the storage based on determining that the current time is within the time window during which to store the second element.

The at least one processing device may be configured to modify (e.g., perform post-processing on) the second element. The at least one processing device may modify (e.g., perform post-processing on) the second element before the at least one processing device sends the second element to the client device. The at least one processing device may modify the second element based on the additional data contained in the URI. For example, the at least one processing device may modify the second element based on inserting, into the second element, one of more of the ID associated with the at least one portion of the content item, the start time associated with the at least one portion of the content item, or the duration associated with the at least one portion of the content item. The at least one processing device may send the modified second element to the client device. If the at least one processing device sends the modified second element to the client device, receiving the second element may comprise receiving the modified second element.

If the second element is contained in the second MPD, receiving the second element from the at least one processing device may comprise receiving the second MPD. If the second element is contained in the second MPD, the at least one processing device may determine the second element based on determining the second MPD. For example, the at least one processing device may determine whether the second MPD is in the storage associated with the at least one processing device. The at least one processing device may be configured to modify (e.g., perform post-processing on) the second element based on modifying the second MPD.

At 208, output of the supplemental content may be caused. Output of the supplemental content during output of the at least one portion of the content item may be caused. Output of the supplemental content may be caused based on replacing the at least one first element in the MPD with the second element. If receiving the second element comprises receiving the modified second element, replacing the at least one first element in the MPD with the second element may comprise replacing the at least one first element in the MPD with the

If the second element is contained in the second MPD, the second element may be extracted from the second MPD. The at least one first element may be replaced with the extracted second element.

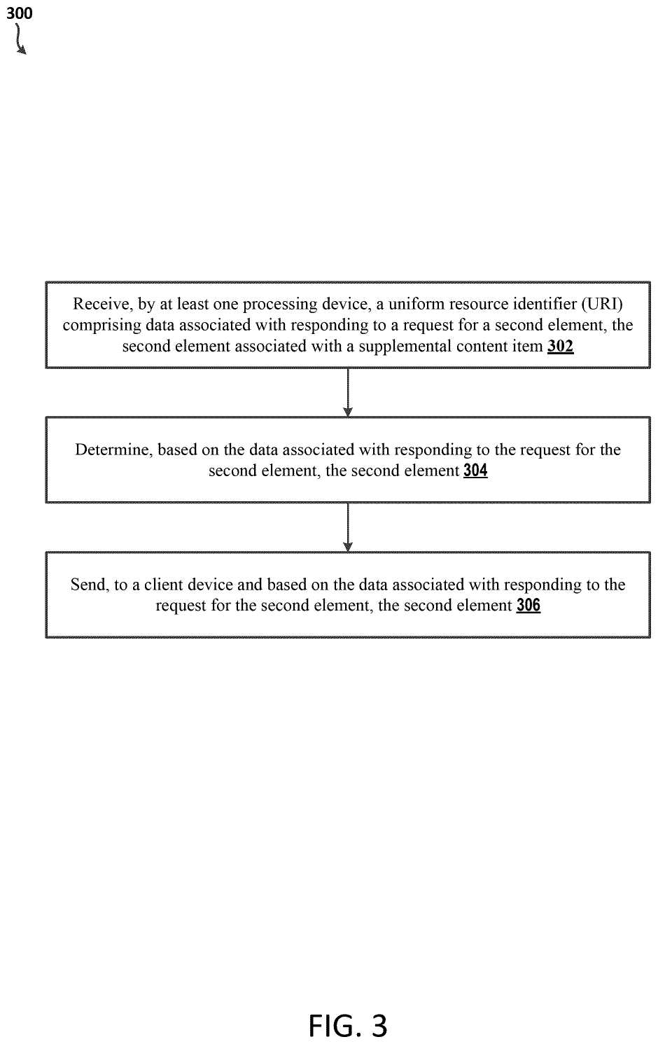

FIG. 3 is a flow diagram illustrating an example method 300. The method 300 may comprise a computer implemented method for content output. A system and/or computing environment, such as the system 100 of FIG. 1 and/or the computing environment of FIG. 5, may be configured to perform the method 300. For example, the processing device(s) 110 of FIG. 1 may be configured to perform the method 300.

At 302, a request for a second element may be received. The request for the second element may be received by at least one processing device. The request for a second element may be received from a client device. The second element may be associated with a supplemental content item. The request for the second element may comprise a URI.

The URI may comprise data associated with responding to the request for the second element. the data associated with responding to the request for the second element comprises one or more of an ID associated with the second element, a time window during which to send the second element, a time window during which to store the second element, an instruction to use replacement content contained in the at least one first element if a failure to respond the request for the second element occurs, or a current time. The URI may further comprise additional data. The additional data may comprise one or more of an ID associated with the at least one portion of the content item, a start time associated with the at least one portion of the content item, and a duration associated with the at least one portion of the content item.

At 304, the second element may be determined. The second element may be determined based on the URI. The second element may be determined based on the data associated with responding to the request for the second element. Determining the second element may comprise sending a request to one or more server devices (e.g., ad servers) for the second element and/or receiving the second element from the server device(s). Determining the second element may comprise retrieving the second element from a storage associated with the at least one processing device.

It may be determined whether the second element is in the storage associated with the at least one processing device. It may be determined whether the second element is in the storage associated with the at least one processing device based on the ID associated with the second element. If it is determined that the second element is in the storage associated with the at least one processing device, determining the second element may comprise retrieving the second element from the storage. Conversely, if it is determined that the second element is not in the storage associated with the at least one processing device, determining the second element may comprise sending the request for the second element to the server device(s), and receiving the second element from the server device(s).

At 306, the second element may be sent. The second element may be sent to the client device. The second element may be sent based on the data associated with responding to the request for the second element. It may be determined whether the current time is within the time window during which to send the second element. Determining whether the current time is within the time window during which to send the second element may comprise comparing the current time to the time window during which to send the second element. Sending the second element may comprise sending the second element to the client device based on determining that the current time is within the time window during which to send the second element. For example, if it is determined the current time is within the time window during which to send the second element, the second element may be sent (e.g., to the client device.) Alternatively, if it is determined that the current time is not within the time window during which to send the second element, the second element may be stored (e.g., cache) in the storage. For example, the second element may be stored (e.g., cached) based on determining that the current time is within the time window during which to store the second element.

The second element may be modified (e.g., post-processed). The second element may be modified before the second element is sent. Modifying the second element may comprise modifying the second element based on the additional data contained in the URI. For example, modifying the second element may comprise inserting, into the second element, one of more of the ID associated with the at least one portion of the content item, the start time associated with the at least one portion of the content item, or the duration associated with the at least one portion of the content item. The modified second element may be sent, such as to the client device.

The client device may receive the second element (or the modified second element). The client device may be configured to cause output of the supplemental content item during output of at least one portion (e.g., at least one supplemental content insertion opportunity) of a content item based on replacing at least one first element in a MPD with the second element. The at least one first element may be associated with the at least one portion of the content item.

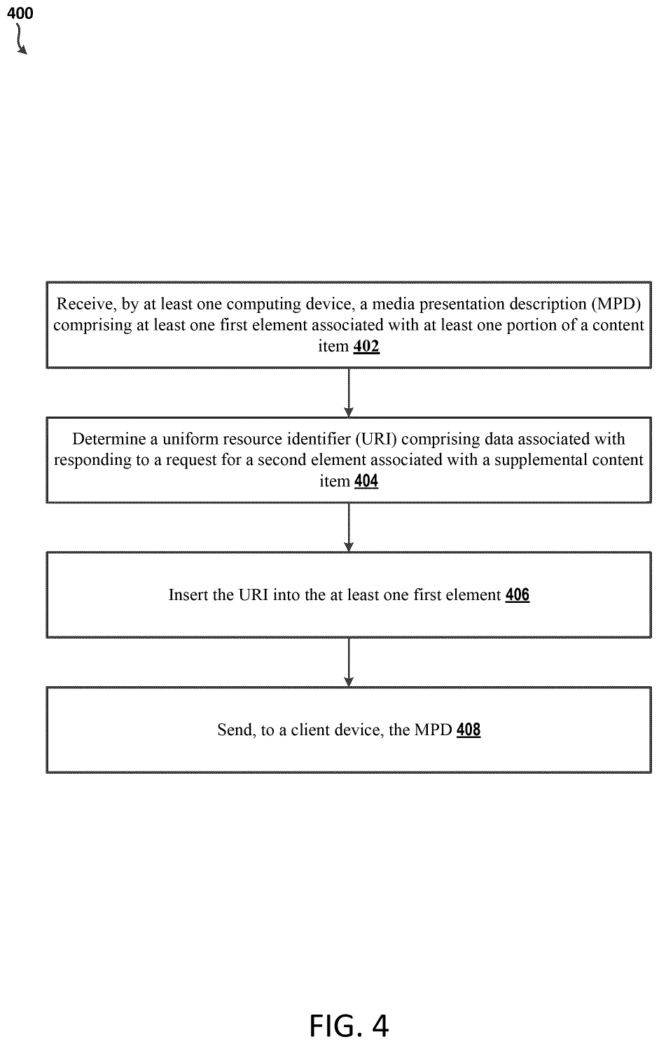

FIG. 4 is a flow diagram illustrating an example method 400. The method 400 may comprise a computer implemented method for content output. A system and/or computing environment, such as the system 100 of FIG. 1 and/or the computing environment of FIG. 5, may be configured to perform the method 400. For example, the computing device(s) 102 of FIG. 1 may be configured to perform the method 400.

At 402, a MPD may be received. The MPD may be received by at least one computing device. The MPD may comprise at least one first element. The at least one first element may be associated with at least one portion of a content item. The at least one portion of the content item may comprise at least one supplemental content insertion opportunity in the content item. The at least one first element may be associated with a first attribute (e.g., @xlink: href) and a second attribute (e.g., @xlink: actuate). The first attribute may contain the network location associated with the at least one first element. The network location may comprise, for example, a HTTP URL link (e.g., using a simplified profile of XLink) associated with the at least one first element. The second attribute of the at least one first element may specify a value of the resolution model associated with the at least one first element.

At 404, a URI may be determined. The URI may comprise data associated with responding to a request for a second element associated with a supplemental content item. The supplemental content item may comprise a supplemental content item to be output during the at least one portion of the content item. The data associated with responding to the request for the second element may comprise one or more of an ID associated with the second element, a time window during which to send the second element, a time window during which to store the second element, an instruction to use replacement content contained in the at least one first element if a failure to respond the request for the second element occurs, and a current time. The URI may further comprise additional data. The additional data may comprise one or more of an ID associated with the at least one portion of the content item, a start time associated with the at least one portion of the content item, and a duration associated with the at least one portion of the content item.

At 406, the URI may be inserted into the at least one first element. Inserting the URI into the at least one first element may comprise inserting the URI into the first attribute (e.g., @xlink: href) of the at least one first element. At 408, the MPD may be sent. For example, the MPD comprising the inserted URI may be sent. The MPD may be sent to a client device. The client device may determine the URI based on the MPD and/or extract the URI from the MPD. The client device may be configured to cause output of the supplemental content item based on sending the URI to at least one processing device. The at least one processing device may be configured to send the second element to the client device based on determining that the current time is within the time window during which to send the second element. The client device may receive the second element from the at least one processing device based on the current time being within the time window during which to send the second element. The client device may cause output of the supplemental content item at least by replacing the at least one first element in the MPD with the second element.

FIG. 5 depicts a computing device that may be used in various aspects, such as one or more of the computing device(s) 102, the client device 104, the processing device(s) 110, and the server device(s) 112 depicted in FIG. 1. With regard to the example architecture of FIG. 1, any of the servers, devices, or components may each be implemented in an instance of a computing device 500 of FIG. 5.

The computer architecture shown in FIG. 5 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 2, FIG. 3, and FIG. 4.

The computing device 500 may include a baseboard, or “motherboard,” which is a printed circuit board to which a multitude of components or devices may be connected by way of a system bus or other electrical communication paths. One or more central processing units (CPUs) 504 may operate in conjunction with a chipset 506. The CPU(s) 504 may be standard programmable processors that perform arithmetic and logical operations necessary for the operation of the computing device 500.

The CPU(s) 504 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 504 may be augmented with or replaced by other processing units, such as GPU(s). The GPU(s) may comprise processing units specialized for but not necessarily limited to highly parallel computations, such as graphics and other visualization-related processing.

A chipset 506 may provide an interface between the CPU(s) 504 and the remainder of the components and devices on the baseboard. The chipset 506 may provide an interface to a random access memory (RAM) 508 used as the main memory in the computing device 500. The chipset 506 may further provide an interface to a computer-readable storage medium, such as a read-only memory (ROM) 520 or non-volatile RAM (NVRAM) (not shown), for storing basic routines that may help to start up the computing device 500 and to transfer information between the various components and devices. ROM 520 or NVRAM may also store other software components necessary for the operation of the computing device 500 in accordance with the aspects described herein.

The computing device 500 may operate in a networked environment using logical connections to remote computing nodes and computer systems through local area network (LAN) 516. The chipset 506 may include functionality for providing network connectivity through a network interface controller (NIC) 522, such as a gigabit Ethernet adapter. A NIC 522 may be capable of connecting the computing device 500 to other computing nodes over a network 516. It should be appreciated that multiple NICs 522 may be present in the computing device 500, connecting the computing device to other types of networks and remote computer systems.

The computing device 500 may be connected to a mass storage device 528 that provides non-volatile storage for the computer. The mass storage device 528 may store system programs, application programs, other program modules, and data, which have been described in greater detail herein. The mass storage device 528 may be connected to the computing device 500 through a storage controller 524 connected to the chipset 506. The mass storage device 528 may consist of one or more physical storage units. A storage controller 524 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 500 may store data on a mass storage device 528 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 528 is characterized as primary or secondary storage and the like.

For example, the computing device 500 may store information to the mass storage device 528 by issuing instructions through a storage controller 524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 500 may further read information from the mass storage device 528 by detecting the physical states or characteristics of one or more particular locations within the physical storage units.

In addition to the mass storage device 528 described above, the computing device 500 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 500.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic citemtes, magnetic tape, magnetic disk storage, other magnetic storage devices, or any other medium that may be used to store the desired information in a non-transitory fashion.

A mass storage device, such as the mass storage device 528 depicted in FIG. 5, may store an operating system utilized to control the operation of the computing device 500. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 528 may store other system or application programs and data utilized by the computing device 500.

The mass storage device 528 or other computer-readable storage media may also be encoded with computer-executable instructions, which, when loaded into the computing device 500, transforms the computing device from a general-purpose computing system into a special-purpose computer capable of implementing the aspects described herein. These computer-executable instructions transform the computing device 500 by specifying how the CPU(s) 504 transition between states, as described above. The computing device 500 may have access to computer-readable storage media storing computer-executable instructions, which, when executed by the computing device 500, may perform the methods described in relation to FIG. 2, FIG. 3, and FIG. 4.

A computing device, such as the computing device 500 depicted in FIG. 5, may also include an input/output controller 532 for receiving and processing input from a number of input devices, such as a keyboard, a mouse, a touchpad, a touch screen, an electronic stylus, or other type of input device. Similarly, an input/output controller 532 may provide output to a display, such as a computer monitor, a flat-panel display, a digital projector, a printer, a plotter, or other type of output device. It will be appreciated that the computing device 500 may not include all of the components shown in FIG. 5, may include other components that are not explicitly shown in FIG. 5, or may utilize an architecture completely different than that shown in FIG. 5.

As described herein, a computing device may be a physical computing device, such as the computing device 500 of FIG. 5. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by a client device, a media presentation description (MPD), wherein the MPD comprises at least one first element associated with at least one portion of a content item, wherein the at least one first element comprises a uniform resource identifier (URI), and wherein the URI comprises data associated with responding to a request for a second element associated with a supplemental content item;
sending, to at least one processing device, the request for the second element, wherein the request comprises the URI;
receiving, from the at least one processing device and based on the data associated with responding to the request for the second element, the second element; and
causing, based on replacing the at least one first element with the second element, output of the supplemental content item during output of the at least one portion of the content item.

2. The method of claim 1, wherein the data associated with responding to the request for the second element comprises one or more of:
an identification (ID) associated with the second element;
a time window during which to send the second element;
a time window during which to store the second element;
an instruction to use replacement content contained in the at least one first element if a failure to respond the request for the second element occurs; and
a current time.

3. The method of claim 2, wherein the at least one processing device is configured to:
determine, based on the ID associated with the second element, that the second element is not in a storage associated with the at least one processing device; and
request, based on determining that the second element is not in the storage associated with the at least one processing device, the second element from at least one server device.

4. The method of claim 2, wherein the at least one processing device is further configured to:
receive the second element; and
send the second element to the client device based on determining that the current time is within the time window during which to send the second element.

5. The method of claim 2, wherein the at least one processing device is further configured to:
receive the second element; and
cause storage of the second element based on determining that the current time is within the time window during which to store the second element.

6. The method of claim 1, wherein the URI further comprises additional data, the additional data comprising one or more of:
an identification (ID) associated with the at least one portion of the content item;
a start time associated with the at least one portion of the content item; and
a duration associated with the at least one portion of the content item.

7. The method of claim 6, wherein the at least one processing device is further configured to:
modify the second element based on inserting, into the second element, one of more of the ID associated with the at least one portion of the content item, the start time associated with the at least one portion of the content item, or the duration associated with the at least one portion of the content item; and
send the modified second element to the client device, wherein replacing the at least one first element with the second element comprises replacing the at least one first element with the modified second element.

8. A method comprising:
receiving, by at least one processing device and from a client device, a request for a second element associated with a supplemental content item, wherein the request for the second element comprises a uniform resource identifier (URI), the URI comprising data associated with responding to the request for the second element;
determining, based on the data associated with responding to the request for the second element, the second element; and
sending, to the client device and based on the data associated with responding to the request for the second element, the second element, wherein the client device is configured to cause output of the supplemental content item during output of at least one portion of a content item based on replacing at least one first element in a media presentation description (MPD) with the second element, wherein the at least one first element is associated with the at least one portion of the content item.

9. The method of claim 8, wherein the data associated with responding to the request for the second element comprises one or more of:
an identification (ID) associated with the second element;
a time window during which to send the second element;
a time window during which to store the second element;
an instruction to use replacement content contained in the at least one first element if a failure to respond the request for the second element occurs; and
a current time.

10. The method of claim 9, further comprising: determining, based on the ID associated with the second element, that the second element is not in a storage associated with the at least one processing device, and
wherein determining the second element comprises requesting, based on determining that the second element is not in the storage associated with the at least one processing device, the second element from at least one server device.

11. The method of claim 9, wherein determining the second element comprises receiving, from at least one server device or from a storage associated with the at least one processing device, the second element, and
wherein sending the second element comprises sending the second element to the client device based on determining that the current time is within the time window during which to send the second element.

12. The method of claim 9, wherein determining the second element comprises receiving, from at least one server device, the second element, the method further comprising:
causing storage of the second element based on determining that the current time is within the time window during which to store the second element.

13. The method of claim 8, wherein the URI further comprises additional data, the additional data comprising one or more of:
an identification (ID) associated with the at least one portion of the content item;
a start time associated with the at least one portion of the content item; and
a duration associated with the at least one portion of the content item.

14. The method of claim 13, further comprising:
modifying the second element based on inserting, into the second element, one of more of the ID associated with the at least one portion of the content item, the start time associated with the at least one portion of the content item, or the duration associated with the at least one portion of the content item, and
wherein sending the second element comprises sending the modified second element to the client device, and wherein replacing the at least one first element with the second element comprises replacing the at least one first element with the modified second element.

15. A method comprising:
receiving, by at least one computing device, a media presentation description (MPD) comprising at least one first element associated with at least one portion of a content item;
determining a uniform resource identifier (URI) comprising data associated with responding to a request for a second element associated with a supplemental content item;
inserting the URI into the at least one first element; and
sending, to a client device, the MPD, wherein the client device is configured to cause output of the supplemental content item during output of the at least one portion of the content item based on sending the URI to at least one processing device and replacing the at least one first element with the second element, the at least one processing device configured to send the second element to the client device based on the data associated with responding to the request for the second element.

16. The method of claim 15, wherein the data associated with responding to the request for the second element comprises one or more of:
an identification (ID) associated with the second element;
a time window during which to send the second element;
a time window during which to store the second element;
an instruction to use replacement content contained in the at least one first element if a failure to respond the request for the second element occurs; and
a current time.

17. The method of claim 16, wherein the at least one processing device is further configured to:
determine, based on the ID associated with the second element, that the second element is not in a storage associated with the at least one processing device; and
request, based on determining that the second element is not in the storage associated with the at least one processing device, the second element from at least one server device.

18. The method of claim 16, wherein the at least one processing device is further configured to:
receive the second element; and
send the second element to the client device based on determining that the current time is within the time window during which to send the second element; or
cause storage of the second element based on determining that the current time is within the time window during which to store the second element.

19. The method of claim 15, wherein the URI further comprises additional data, the additional data comprising one or more of:
an identification (ID) associated with the at least one portion of the content item;
a start time associated with the at least one portion of the content item; and
a duration associated with the at least one portion of the content item.

20. The method of claim 19, wherein the at least one processing device is further configured to:
modify the second element based on inserting, into the second element, one of more of the ID associated with the at least one portion of the content item, the start time associated with the at least one portion of the content item, or the duration associated with the at least one portion of the content item; and
send the modified second element to the client device, wherein replacing the at least one first element with the second element comprises replacing the at least one first element with the

21. A method comprising:
receiving, by a client device, a manifest file associated with a content item, wherein the manifest file comprises data indicating instructions for responding to a request for a supplemental content item;
sending, to at least one processing device, the request for the supplemental content item, wherein the request comprises the data indicating the instructions for responding to the request;
receiving, from the at least one processing device and based on the data indicating the instructions for responding to the request, the supplemental content item; and
causing output of the supplemental content item during output of at least one portion of the content item.

22. The method of claim 21, wherein the data associated with responding to the request for the supplemental content item comprises one or more of:
an identification (ID) associated with the supplemental content item;
a time window associated with sending the supplemental content item;
a time window associated with storing the supplemental content item;
an instruction to use replacement content contained in the manifest file if a failure to respond the request for the supplemental content item occurs; and
a current time.

23. The method of claim 22, wherein the at least one processing device is configured to:
determine, based on the ID associated with the supplemental content item, that the supplemental content item is not in a storage associated with the at least one processing device; and
request, based on determining that the supplemental content item is not in the storage associated with the at least one processing device, the supplemental content item from at least one server device.

24. The method of claim 22, wherein the at least one processing device is further configured to:
receive the supplemental content item; and
send the supplemental content item to the client device based on determining that the current time is within the time window associated with sending the supplemental content item.

25. The method of claim 22, wherein the at least one processing device is further configured to:
receive the supplemental content item; and
cause storage of the supplemental content item based on determining that the current time is within the time window associated with storing the supplemental content item.
